(19) United States
(12) Patent Application Publication
(10) Pub. No.: US 2022/0222251 A1
(43) Pub. Date: Jul. 14, 2022

(54) SEMICONDUCOR DEVICE FOR COMPUTING NON-LINEAR FUNCTION USING A LOOK-UP TABLE

(71) Applicants: SK hynix Inc., Icheon (KR); Korea University Research and Business Foundation, Seoul (KR)

(72) Inventors: Seok Young KIM, Seoul (KR); Changhyun KIM, Seongnam (KR); Wonjun LEE, Seoul (KR); Seonwook KIM, Namyangju (KR)

(21) Appl. No.: 17/469,857

(22) Filed: Sep. 8, 2021

(30) Foreign Application Priority Data
Jan. 14, 2021 (KR) 10-2021-0005215

(51) Int. Cl. G06F 16/2455; G06F 7/57

(52) U.S. Cl. CPC G06F 16/2455; G06F 7/57

(57) ABSTRACT

A semiconductor device includes a look-up table storing a plurality of input values defining a plurality of sections, wherein a range of function values corresponding to the plurality of input values is equally divided into the plurality of sections; and an operation circuit configured to receive a given input value, determine a target section where the given input value is included by searching the look-up table, and determine a function value corresponding to the given input value based on the target section.

### CROSS-REFERENCE TO RELATED APPLICATION

The present application claims priority under 35 U.S.C. § 119(a) to Korean Patent Application No. 10-2021-0005215, filed on Jan. 14, 2021, which is incorporated herein by reference in its entirety.

### BACKGROUND

### 1. Technical Field

Various embodiments generally relate to a semiconductor device for computing a non-linear function using a look-up table.

### 2. Related Art

Floating-point numbers are widely used in neural network computation using a central processing unit (CPU), a graphics processing unit (GPU), an accelerator, etc.

The bfloat16 (Brain Floating Point) floating-point format is a computer number format occupying 16 bits in a computer memory, and includes 1 sign bit, 8 exponent bits, and 7 mantissa bits.

An activation function in a neural network defines how the weighted sum of the input is transformed into an output from a node or nodes in a layer of the network.

In this case, the activation function is generally a non-linear function, and may use a look-up table (LUT) for the computation.

In the prior art, a range of input values is predefined and is equally divided, and a function value corresponding thereto is calculated in advance and stored in a look-up table, but this method lacks applicability depending on the function.

For example, if input values range from 0 to 5, function values corresponding to the input values 0, 1, 2, 3, 4, and 5 are pre-computed, and the pre-computed function values are stored in corresponding addresses of the look-up table.

For the floating-point numbers, an interval between two input values doubles for every increase in the exponent by 1. Thus, it is difficult to evenly distribute intervals between input values when using the floating-point numbers.

Accordingly, when referring to a look-up table generated by equally spaced input values as in the prior art using the floating-point numbers, a large error may occur in the accuracy of the function values.

Also, since the input value may be in an infinite range, the size of the look-up table may be excessively increased in order to ensure the accuracy of the computation.

### SUMMARY

In accordance with an embodiment of the present disclosure, a semiconductor device may include a look-up table storing a plurality of input values defining a plurality of sections, wherein a range of function values corresponding to the plurality of input values is equally divided into the plurality of sections; and an operation circuit configured to receive a given input values, determine a target section where the given input value is included by searching the look-up table, and determine a function value corresponding to the given input value based on the target section.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate various embodiments, and explain various principles and advantages of those embodiments.

FIG. 1 illustrates a semiconductor device according to an embodiment of the present disclosure.

FIG. 2 illustrates an example of a non-linear function.

FIG. 3 illustrates a look-up table according to an embodiment of the present disclosure.

FIGS. 4A and 4B illustrate a relation between an address of a look-up table and a corresponding function value according to an embodiment of the present disclosure.

FIG. 5 illustrates an operation circuit according to an embodiment of the present disclosure.

FIG. 6 illustrates an operation circuit according to another embodiment of the present disclosure.

FIG. 7 illustrates a semiconductor device according to another embodiment of the present disclosure.

### DETAILED DESCRIPTION

The following detailed description references the accompanying figures in describing illustrative embodiments consistent with this disclosure. The embodiments are provided for illustrative purposes and are not exhaustive. Additional embodiments not explicitly illustrated or described are possible. Further, modifications can be made to presented embodiments within the scope of teachings of the present disclosure. The detailed description is not meant to limit this disclosure. Rather, the scope of the present disclosure is defined in accordance with claims and equivalents thereof. Also, throughout the specification, reference to “an embodiment” or the like is not necessarily to only one embodiment, and different references to any such phrase are not necessarily to the same embodiment(s).

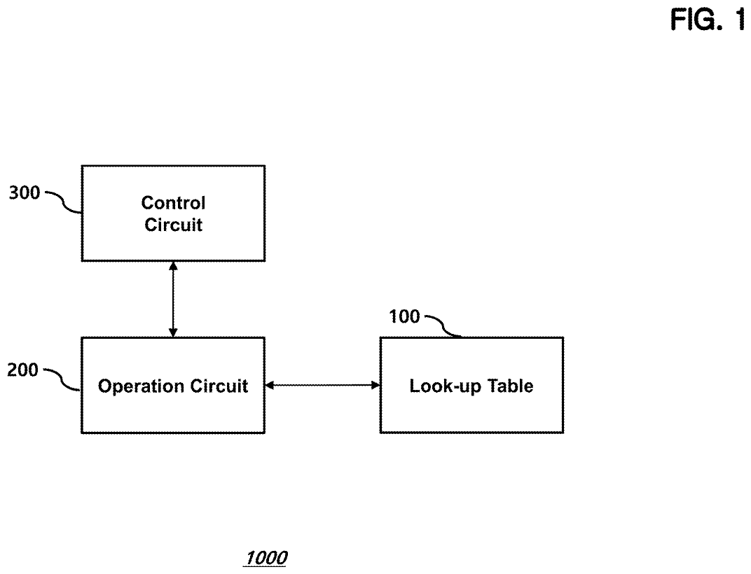

FIG. 1 is a block diagram illustrating a semiconductor device 1000 according to an embodiment of the present disclosure.

The semiconductor device 1000 includes a look-up table 100, an operation circuit 200, and a control circuit 300 .

In the present embodiment, the look-up table 100 is different from that of the prior art since the look-up table 100 stores an input value x corresponding to an address.

The look-up table 100 according to the present embodiment will be described in detail below.

The operation circuit 200 queries the look-up table 100 and outputs a function value y or f(x) corresponding to a given input value x.

The operation circuit 200 may further perform general computations including a multiplication and accumulation (MAC) operation, which is often used in a neural network operation.

For example, the operation circuit 200 may perform a MAC operation between two vectors and determine a function value that receives a result of the MAC operation as an input value.

The control circuit 300 may control the operation circuit 200 to perform a function computation or a general computation.

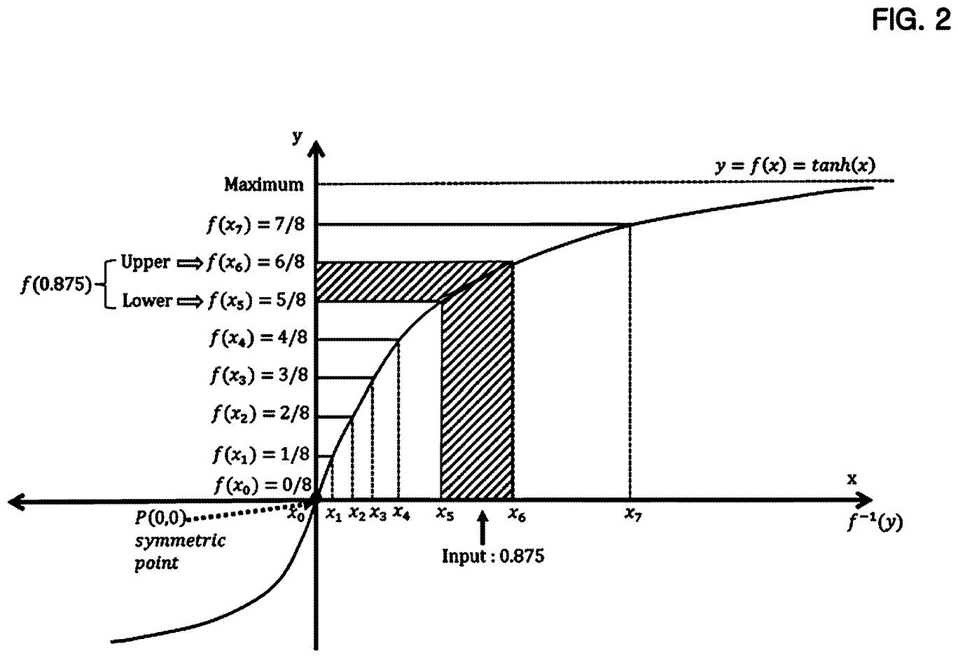

FIG. 2 is a graph illustrating an example of a nonlinear function.

The graph of FIG. 2 shows a hyperbolic tangent function used as an activation function in a neural network operation.

The hyperbolic tangent function has a symmetric characteristic using an input value x that is 0 as a symmetric point, and has a monotonically increasing characteristic.

In this embodiment, the look-up table 100 of FIG. 1 only stores zero (0) and positive function values considering the symmetry characteristic.

First, a range of function values is equally divided between 0 and a maximum value 1.

In this embodiment, the range is divided into 8 sections, and thus the size of each section becomes 1/8.

A starting point of each section corresponds to an address of the look-up table 100.

For example, a function value y₀ or f(x₀) corresponds to an address “000” of the look-up table 100, and a function value y₇ or f(x₇) corresponds to an address “111” of the look-up table 100.

In the present embodiment, the look-up table 100 stores input values x rather than function values f(x). Each of the 8 sections is defined by two input values respectively corresponding to two consecutive addresses. Therefore, the two input values respectively represent a starting point and an ending point of the section. For example, a first section is defined by X₀ and X₁, a second section is defined by X₁ and X₂, and so on.

Accordingly, for example, an input value x₀ corresponding to the function value f(x₀) is stored in the address “000” of the look-up table 100, and an input value x₇ corresponding to the function value f(x₇) is stored in the address “111” of the look-up table 100.

In this case, the input value x corresponds to a value determined by computing an inverse of the hyperbolic tangent function.

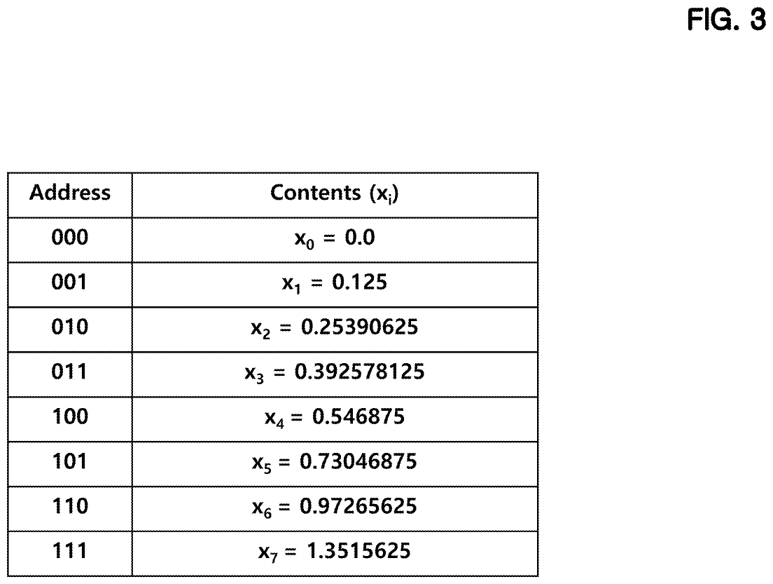

FIG. 3 shows a look-up table 100 corresponding to the nonlinear function of FIG. 2.

In this embodiment, the input value x may be stored in the bfloat16 format.

A bfloat16 number is a 16-bit number where 7 bits from 0th to 6th bits are mantissa bits, 8 bits from 7th to 14th bits are exponent bits, and 15th bit is a sign bit.

When S is a sign bit, M is the mantissa bits, and E is a magnitude of the exponent bits, the corresponding floating point number can be expressed by Equation 1 as below.

(−1)^{S}×1.M×2^{E-127} (Equation 1)

For example, when the mantissa bits are “0101010”, 1.M in Equation 1 represents 1.0101010.

Returning to FIG. 1 , the operation circuit 200 searches the look-up table 100 to find an address corresponding to a section to which a given input value x belongs, the look-up table 100 including addresses that correspond to a plurality of sections.

As shown in FIGS. 2 and 3, when the given input value x is 0.875, a corresponding function value exists in a section between a first function value corresponding to an address “101” and a second function value corresponding to an address “110”.

The operation circuit 200 may determine the first function value or the second function value as the function value corresponding to the given input value x.

When the number of sections is sufficiently large, a difference between the first function value and the second function value becomes sufficiently small, so that even if any one of the first function value and the second function value is selected as the function value corresponding to the given input value x, an error becomes sufficiently small.

In another embodiment, the operation circuit 200 may interpolate the first function value and the second function value to determine the function value corresponding to the given input value x. In this case, a conventionally known interpolation technique may be applied.

The following disclosure assumes that the second function value is determined to be the function value corresponding to the given input value x.

In this embodiment, since the range of function values is equally divided, a relationship between a function value and an address can be known in advance through a simple operation.

That is, when an address corresponding to an input value x is found, a function value y corresponding to the input value x can be directly derived using the corresponding address.

For example, if a minimum value of the function values in the range is m, a maximum value of the function values in the range is M, the total number of sections is N, and an identification number of a section to which the input value x belongs is A, where A is a natural number, the function value y can be calculated as follows.

$$y = f ( x ) = m + \frac{M - m}{N} \times A \qquad ( Equation 2 )$$

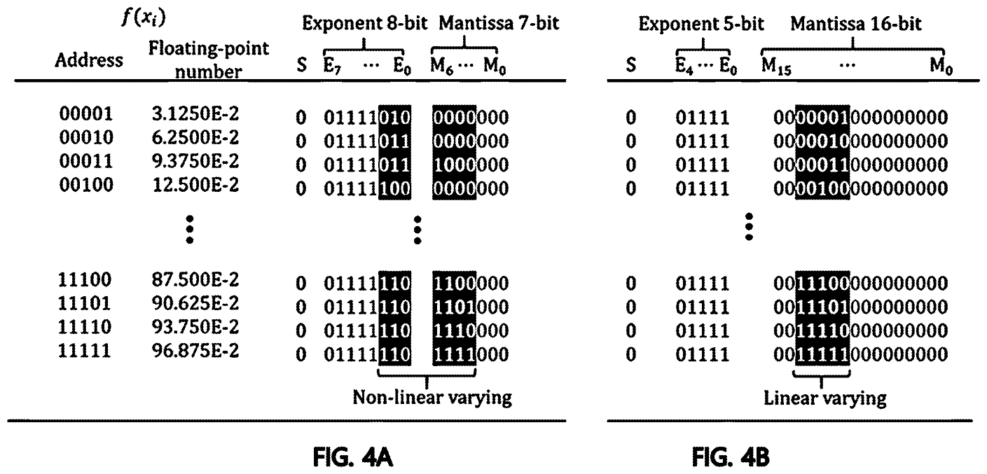

FIGS. 4A and 4B illustrate a relationship between an address of the look-up table 100 and a corresponding function value.

FIGS. 4A and 4B are different from the graph of FIG. 2 in that an address of the look-up table 100 has 5 bits rather than 3 bits.

At this time, it is assumed that the minimum and maximum values of the function values are known in advance. In FIGS. 4A and 4B, the minimum value is 0 and the maximum value is 1.

Accordingly, a function value interval between two consecutive addresses becomes 1/32, which is 0.03125.

In FIG. 4A, function values f(xᵢ) are shown on the right side of corresponding addresses.

FIG. 4A also shows function values f(xᵢ) in the form of the bfloat16 format.

The technique for converting a function value into the bfloat16 format is well known, so a detailed description thereof will be omitted.

In FIG. 4A, inverted portions indicate a portion where bit values are changed according to an address.

There is no way to directly derive a function value of the bfloat16 format using a corresponding address.

Accordingly, in the present embodiment, numbers of the bfloat16 format of FIG. 4A are converted into numbers of a format shown in FIG. 4B.

In FIG. 4B, exponent bits corresponds to the upper 5 bits of the exponent bits of the bfloat16 format, and mantissa bits are extended to 16 bits.

In FIG. 4B, each number includes 22 bits that correspond to the number of bits of a number used in the operation circuit 200.

The mantissa bits of FIG. 4B include a bit array that matches the address. A technique for converting a number of the bfloat16 format of FIG. 4A into a number of the format shown in FIG. 4B is well-known by previous works such as [symbol] Vangal, S. R. et al. “A 6.2-GFlops Floating-Point Multiply-Accumulator With Conditional Normalization.” IEEE Journal of Solid-State Circuits 41 (2006): 2314-2323. [symbol] , and [symbol] Z. Luo and M. Martonosi, “Accelerating pipelined integer and floating-point accumulations in configurable hardware with delayed addition techniques,” in IEEE Transactions on Computers, vol. 49, no. 3, pp. 208-218, March 2000, doi: 10.1109/12.84112.5 [symbol] .

When the operation circuit 200 finds an address corresponding to an input value x, the operation circuit 200 may store a number corresponding to the address in the format shown in FIG. 4B.

When the operation circuit 200 outputs a function value, a number stored therein in the format as shown in FIG. 4B may be converted into a number of the bfloat16 format and then output.

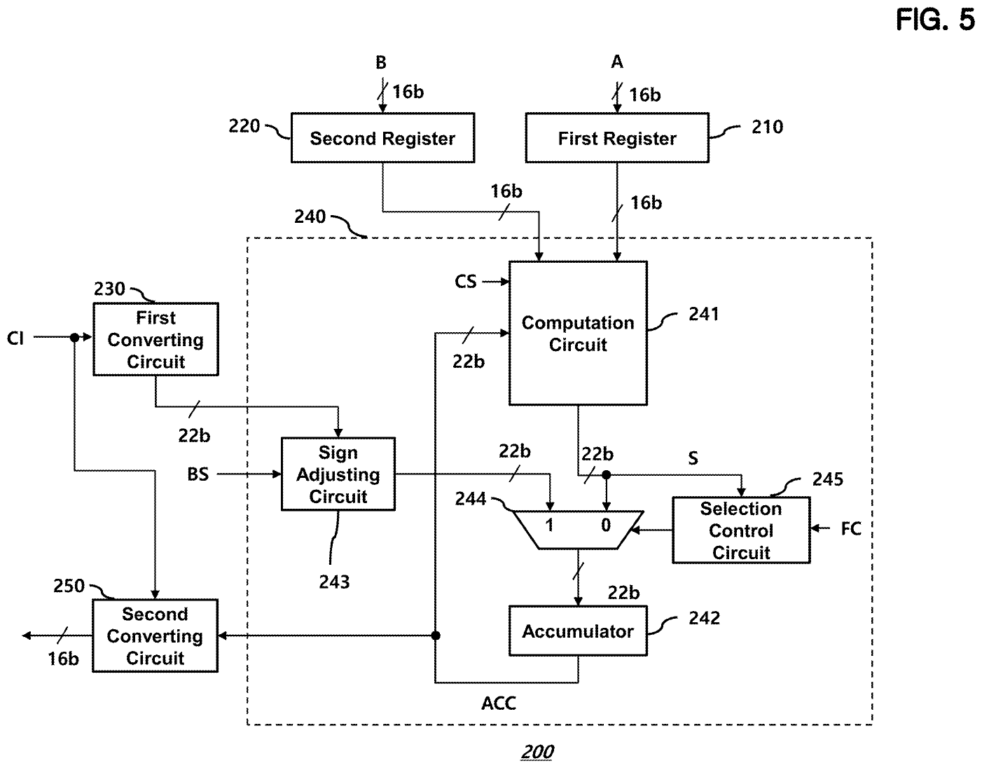

FIG. 5 is a block diagram illustrating the operation circuit 200 of FIG. 1 according to an embodiment of the present disclosure.

The operation circuit 200 may perform various general computations as well as a function computation that provides a function value corresponding to an input value.

The operation circuit 200 includes a first register 210, a second register 220, a first converting circuit 230, an arithmetic logic unit (ALU) 240, and a second converting circuit 250.

The first register 210 stores a first input value A in the bfloat16 format, and the second register 220 stores a second input value B in the bfloat16 format, each of the first input value A and the second input value B including 16 bits.

When performing a general computation other than the function computation, the first register 210 and the second register 220 store two operands.

When the function computation is performed, the first register 210 stores an input value xᵢ read from the look-up table 100 of FIG. 1, and the second register 220 stores a given input value x.

As shown in FIGS. 4A and 4B, the first converting circuit 230 converts a current address of the look-up table 100 into a number of the format shown in FIG. 4B.

The first converting circuit 230 may use control information CI provided by the control circuit 300 of FIG. 1 in the conversion process.

The control information CI may include a type of a function, symmetry information of the function, minimum and maximum function values, and a function computation signal FC.

The second converting circuit 250 converts a number in the format of FIG. 4B into a number in the bfloat16 format.

Since the specific conversion technique of the first converting circuit 230 and the second converting circuit 250 is the same as that described with reference to FIGS. 4A and 4B, a detailed description thereof will not be repeated.

The ALU 240 includes a computation circuit 241, an accumulator 242, a sign adjusting circuit 243, a selection circuit 244, and a selection control circuit 245.

The computation circuit 241 receives values stored in the first register 210, the second register 220, and the accumulator 242 as inputs, and performs various computations according to a computation selection signal CS provided by the control circuit 300.

If the values stored in the first register 210, the second register 220, and the accumulator 242 are represented as A, B, and ACC, respectively, the computation circuit 241 may perform various computations such as A+B, A−B, A×B+ACC, ACC+A, ACC+B, ACC−A, ACC−B, and so on.

The computation circuit 241 may extend a result of computation to 22 bits to reduce an error occurring during repetitive computations.

The 22-bit data may have, for example, a form in which mantissa bits and exponent bits of a number of the bfloat16 format are respectively increased.

The selection circuit 244 selects one of an output of the computation circuit 241 and an output of the sign adjusting circuit 243, and outputs the selected one to the accumulator 242.

The selection control circuit 245 controls the selection circuit 244 to select the output of the computation circuit 241 when a general computation such as an MAC computation is performed. The selection control circuit 245 controls the selection circuit 244 to select the output of the sign adjusting circuit 243 when the function computation is performed.

For example, the selection control circuit 245 controls the selection circuit 244 so that the selection circuit 244 selects the output of the computation circuit 242 when a sign bit S is 0 and selects the output of the sign adjusting circuit 243 when the sign bit S is 1.

The sign bit S corresponds to a sign bit of the output of the computation circuit 241.

The control circuit 300 may instruct the function computation or the general computation by providing the function computation signal FC to the selection control circuit 245.

In order to perform the MAC computation among general computations, the first register 210 and the second register 220 may sequentially receive elements of two vectors.

The computation circuit 241 may multiply the two corresponding elements A and B from the first and second registers 210 and 220, add a result of the multiplication to the value ACC stored in the accumulator 242, and output a result of the addition.

A specific computation performed by the computation circuit 241 may be selected according to the computation selection signal CS provided by the control circuit 300.

The selection circuit 244 provides the output of the computation circuit 241 to the accumulator 242, and the accumulator 242 uses an output of the selection circuit 244 to update the value ACC stored therein.

By sequentially performing these operations on a plurality of elements, the MAC computation on two vectors can be completed.

The second converting circuit 250 may output an operation result in the form of bfloat16 format by adjusting exponent bits and mantissa bits in 22-bit data ACC output from the accumulator 246.

Next, the function computation is started.

During the function computation, the second register 220 stores the given input value x.

During the function computation, the first register 210 sequentially stores input values xi read from the look-up table 100.

The control circuit 300 may sequentially read the input values xi stored in the look-up table 100 and store them in the first register 210.

In another embodiment, a plurality of input values read from the look-up table 100 may be stored in the first register 210 by increasing a storage space of the first register 210, and the input values stored in the first register 210 may be sequentially output.

The computation circuit 241 performs an operation of subtracting the input value xi from the given input value x. This may also be controlled according to the computation selection signal CS provided by the control circuit 300.

When the given input value x is larger than the input value xi, the sign bit S of the data output from the computation circuit 241 becomes 0, and when the input value xi is larger than the given input value x, the sign bit S becomes 1.

If the sign bit S is 0, the above operation is repeated using a next input value xi stored in the look-up table 100.

These repetitive operations may be performed according to address count operations of the control circuit 300. In this case, an address of the look-up table 100 is provided to the operation circuit 200.

When the sign bit S becomes 1, the above-described operation is terminated.

For example, referring to FIGS. 2 and 3, if the given input value x is 0.875, the sign bit S becomes 1 when the stored input value xi becomes x6 that is larger than 0.875.

The first converting circuit 230 converts an address corresponding to the input value xi read from the look-up table 100 into a number in the format shown in FIG. 4B, and outputs the resulting number to the sign adjusting circuit 243.

The sign adjusting circuit 243 adjusts a sign at the output of the first converting circuit 230 with reference to the symmetry of the function and a sign bit BS of the given input value x, and outputs a correct function value to the selection circuit 244.

Information on the symmetry of the function, i.e., symmetry information of the function, may be obtained by referring to the aforementioned control information CI. The control information CI may be provided through the first converting circuit 230 or may be provided by the control circuit 300.

At this time, the selection control circuit 245 selects the output of the sign adjusting circuit 243, and the accumulator 242 stores the output of the sign adjusting circuit 243.

The value ACC stored in the accumulator 242 has a format as shown in FIG. 4B, and the second converting circuit 250 may convert the value ACC into a number of the bfloat16 format as shown in FIG. 4A and output a converted value.

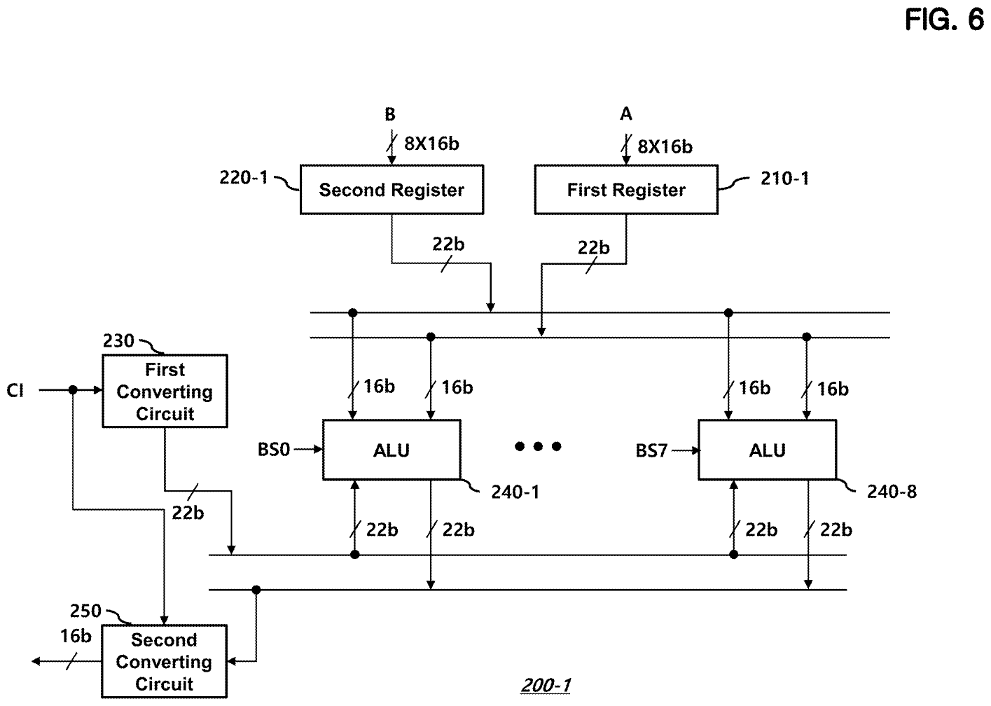

FIG. 6 is a block diagram illustrating an operation circuit 200-1 according to another embodiment of the present invention.

In the embodiment of FIG. 6 , a first register 210-1 and a second register 220-1 are different from those shown in FIG. 5 in that each of them stores 8 16-bit elements therein.

The operation circuit 200-1 includes a plurality of ALUs, e.g., eight ALUs 240-1 to 240-8, and may perform operations on corresponding elements in parallel.

Since the configuration and operation of each of the plurality of ALUs 240-1 to 240-8 are substantially the same as those of the ALU 240 shown in FIG. 5, a description thereof will not be repeated.

Since it can be easily seen from the embodiment of FIG. 5 that a general operation is performed in parallel using the plurality of ALUs 240-1 to 240-8, a detailed description thereof will be omitted.

It is also apparent from the foregoing disclosure to perform a plurality of function computations in parallel using the plurality of ALUs 240-1 to 240-8.

In the function computation, a first converting circuit 230 converts a function value corresponding to a current address of the look-up table 100 of FIG. 1 into a format as shown in FIG. 4B.

Each of the plurality of ALUs 240-1 to 240-8 may adjust a sign at an output of the first converting circuit 230 according to a corresponding one of sign bits BS0 to BS7 of the 8 16-bit elements stored in the second register 220-1, and then store it in an internal accumulator.

A second converting circuit 250 converts values stored in the accumulators of the plurality of ALUs 240-1 to 240-8 into numbers of the bfloat16 format and outputs the converted values.

Although the above disclosure is based on a monotonically increasing or monotonically decreasing nonlinear function, the above description may be extended to any nonlinear function.

In an embodiment, an input value may be divided into a plurality of sections based on whether a function value monotonically decreases or monotonically increases, and a plurality of look-up tables, which are independent from each other, may be generated for the plurality of sections, respectively.

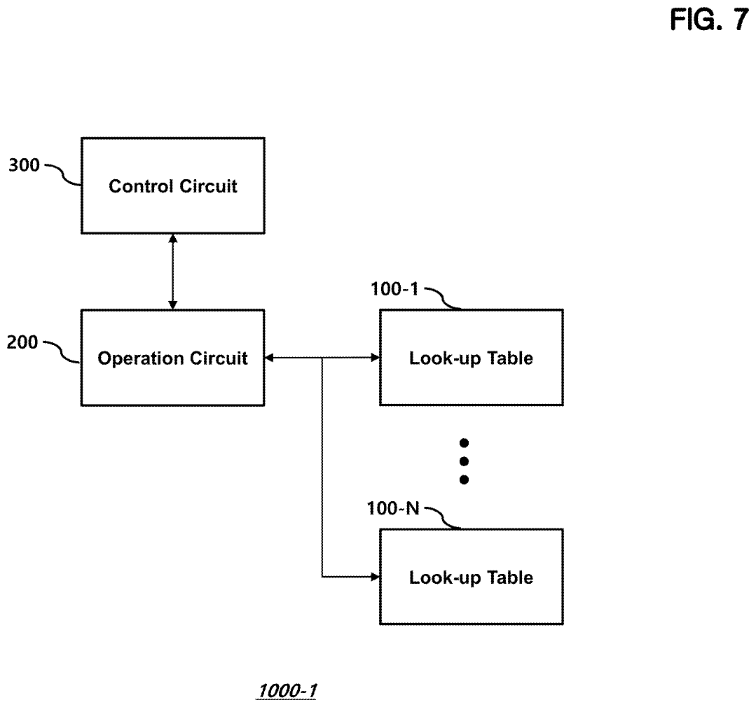

FIG. 7 is a block diagram illustrating a semiconductor device 1000-1 according to another embodiment of the present disclosure.

The semiconductor device 1000-1 may include a plurality of lookup tables 100-1 to 100-N respectively corresponding to a plurality of sections. Each of the plurality of lookup tables 100-1 to 100-N corresponds to a section in which a function value monotonically increases or monotonically decreases.

Since a method of generating each look-up table and a method of computing a function using the same are substantially the same as those described above, a detailed description thereof will be omitted.

Although various embodiments have been illustrated and described, various changes and modifications may be made to the described embodiments without departing from the spirit and scope of the invention as defined by the following claims.

What is claimed is:

1. A semiconductor device, comprising:
a look-up table storing a plurality of input values defining a plurality of sections, wherein a range of function values corresponding to the plurality of input values is equally divided into the plurality of sections; and
an operation circuit configured to receive a given input value, determine a target section where the given input value is included by searching the look-up table, and determine a function value corresponding to the given input value based on the target section.

2. The semiconductor device of claim 1, wherein each of the plurality of input values corresponds to one of a starting point and an ending point of a section of the plurality of sections.

3. The semiconductor device of claim 2, wherein the operation circuit determines, as the function value, one of a first function value and a second function value, the first and second function values respectively corresponding to a starting point and an ending point of the target section.

4. The semiconductor device of claim 2, wherein the operation circuit determines, as the function value, an interpolation value of a first function value and a second function value, the first and second function values respectively corresponding to a starting point and an ending point of the target section.

5. The semiconductor device of claim 1, wherein the operation circuit determines the target section corresponding to the given input value by sequentially searching addresses of the look-up table.

6. The semiconductor device of claim 1, wherein the operation circuit includes:
a first converting circuit configured to output a function value corresponding to a current address of the look-up table; and
an arithmetic logic unit (ALU) configured to store an output of the first converting circuit according to the given input value and an input value stored in the look-up table that corresponds to the current address of the look-up table.

7. The semiconductor device of claim 6, wherein the ALU includes:
a computation circuit configured to perform a subtraction operation on the given input value and the input value stored in the look-up table that corresponds to the current address of the look-up table; and
an accumulator configured to store one of the output of the first converting circuit and an output of the computation circuit according to a sign of the output of the computation circuit.

8. The semiconductor device of claim 7, further comprising a control circuit configured to designate the current address of the look-up table.

9. The semiconductor device of claim 8, wherein the control circuit sequentially changes the current address until the sign of the output of the computation circuit changes.

10. The semiconductor device of claim 7, wherein the ALU further includes a selection circuit configured to select and output one of the output of the computation circuit and the output of the first converting circuit according to a sign bit of the output of the computation circuit.

11. The semiconductor device of claim 10, further comprising a sign adjusting circuit configured to adjust a sign of the output of the first converting circuit by referring to a sign bit of the given input value and symmetry information of a function and provide an output of adjusting the sign to the selection circuit.

12. The semiconductor device of claim 6, further comprising a first register storing the input value stored in the look-up table and a second register storing the given input value.
